(19) United States
(12) Patent Application Publication
(10) Pub. No.: US 2024/0423369 A1
(43) Pub. Date: Dec. 26, 2024

(54) CHAIR MECHANISM FOR AN ITEM OF FURNITURE FOR SITTING AND RECLINING

(71) Applicant: CIAR S.P.A., Pesaro (IT)

(72) Inventor: Diego Loccioni, Pesaro (IT)

(21) Appl. No.: 18/731,710

(22) Filed: Jun. 3, 2024

(30) Foreign Application Priority Data
Jun. 26, 2023 (DE) 202023103511

(51) Int. Cl. A47C 1/032; A47C 1/034

(52) U.S. Cl. CPC A47C 1/032; A47C 1/0345

(57) ABSTRACT

The chair mechanism according to the invention for an item of furniture for sitting and reclining has a seat and a backrest, wherein the backrest has a lower backrest frame and an upper backrest frame, and the lower backrest frame is coupled to the seat so as to be capable of pivoting about a first pivot axis and the lower backrest frame is coupled to the upper backrest frame so as to be capable of pivoting about a second pivot axis, and wherein a first actuator is provided for adjusting the angle between the seat and the lower backrest frame and a second actuator is provided for adjusting the angle between the lower backrest frame and the upper backrest frame. Furthermore, a lumbar support is provided which is attached to the upper or lower backrest frame and is adjustably mounted relative to the lower and/or upper backrest frame.

The invention relates to a chair mechanism for an item of furniture for sitting and reclining having a seat and a backrest, as well as to an actuator for adjusting the angle between the seat and the backrest.

These can be, in particular, recliner or relaxation chairs which can usually be brought from an upright basic position into at least one reclining position. Retractable and extendable footrests, which increase the comfort in the reclining position, are usually also provided. Such chairs are extremely comfortable and promote relaxation.

Almost everyone has to deal with back pain in the course of their life, which is caused in particular by lack of exercise, over-exertion and incorrect nutrition, but above all by long and incorrect sitting. Relaxing or recliner chairs are therefore perceived as very pleasant and relaxing.

From DE 20 2019 100 213 U1, a relaxation chair with an aid for standing up is known, which comprises a footrest, a seat and a backrest, which can be brought from a basic position into a raised position to facilitate standing up or at least into a relaxation position with the footrest extended.

Furthermore, EP 3 143 902 B1 discloses a recliner chair comprising a seat, a backrest and a footrest, which has a footrest adjustment mechanism with a first actuator for extending and retracting the footrest and a seat and backrest adjustment mechanism with a second actuator for adjusting the seat and the backrest.

Although a relaxed reclining position is perceived by the user as very pleasant, passive reclining is no substitute for movement of the body, such as occurs, for example, when walking or taking part in sport. However, in some circumstances natural movement of the body is not always possible to a sufficient extent for the most varied reasons (lack of time, physical ailments). So-called massage chairs have therefore been developed which are equipped with massage elements, for example massage rollers in the backrest. Actuation of the massage function has a relaxing effect on the back muscles and can relieve cramps and tension. Such a massage chair is known, for example from EP 1 738 736 B1. However, such massage chairs are relatively complex and expensive due to the technology built into the backrest.

From DE 10 2020107 243 A1, in addition an item of furniture for sitting and reclining is known that has a seat, a backrest and an adjustment mechanism for changing the position of the seat and/or the backrest between at least a first and a second reclining position, the adjustment mechanism having at least one actuator and a controller, and the controller providing at least one positioning mode for positioning the seat and/or the backrest in the first or second reclining position. Furthermore, the controller has a relaxation mode for repeatedly and continuously moving the seat and/or the backrest back and forth between the first and the second reclining positions.

Sitting and reclining chairs, such as are known from DE 20 2019 100 213 U1 and EP 3 143 902 B1, usually only have one positioning mode for adjusting the item of furniture for sitting and reclining, for example, from an upright basic position into a first reclining position or a second reclining position. DE 10 2020107 243 A1 makes use of this already existing technology by adding an activatable relaxation mode which enables a back and forth movement of the seat and/or the backrest between the first and the second reclining positions. In this way, the user experiences a constant movement, which has a very beneficial and in particular relaxing effect on the user. The existing actuator(s) can be used for implementation, so that only a change of the controller is required.

The invention is based on the object of specifying a chair mechanism that allows additional possibilities for activating the body of a user.

According to the invention, this object is achieved by the features of claim 1.

The chair mechanism according to the invention for an item of furniture for sitting and reclining comprises a seat and a backrest, wherein the backrest has a lower backrest frame and an upper backrest frame, and the lower backrest frame is coupled to the seat so as to be capable of pivoting about a first pivot axis and the lower backrest frame is coupled to the upper backrest frame so as to be capable of pivoting about a second pivot axis, and wherein a first actuator is provided for adjusting the angle between the seat and the lower backrest frame and a second actuator is provided for adjusting the angle between the lower backrest frame and the upper backrest frame. Furthermore, a lumbar support is provided which is attached to the upper or lower backrest frame and is adjustably mounted relative to the lower and/or upper backrest frame.

The two-part backrest offers the possibility of mobilizing and activating the user's back region to a particular degree.

Further embodiments of the invention are the subject matter of the dependent claims.

In order to enable different program sequences, the first actuator is expediently designed for a pivot range around the first pivot axis of 25°+/−5°. For this purpose, the first actuator for adjusting the angle between the seat and the lower backrest frame—measured at the front side of the chair mechanism—can preferably be designed between a minimum angle of 100° and a maximum angle of 125°, in each case+/−10°.

For the second actuator, a pivot range around the second pivot axis of 35°+/−5° has proven to be particularly advantageous, wherein the second actuator is designed to adjust the angle between the lower backrest frame and the upper backrest frame-measured at a front side of the chair mechanism-preferably between a minimum angle of 155° and a maximum angle of 200°, in each case+/−10°.

To increase comfort, it has proven useful to provide a footrest that is mounted on the seat so as to be capable of being extended and retracted. The first actuator can be used to extend and retract the footrest using a suitable seat and footrest mechanism. Within the scope of the invention, it would however also be conceivable for the footrest to be extended and retracted using its own actuator.

According to one embodiment, the lumbar support can be attached to the upper backrest frame and pivot with the upper backrest frame about the second pivot axis. In another variant, however, a further actuator can be provided for the relative adjustment of the lumbar support with respect to the upper and/or lower backrest frame.

The lumbar support preferably has a lumbar support plate which extends transversely to a longitudinal central axis of the chair mechanism in the region of the lower backrest frame. The lumbar support can here be arranged in such a way that the distance between the lumbar support plate and the lower backrest frame changes when the second actuator is actuated. Furthermore, the lumbar support could be arranged such that an adjustment of the angle between the upper backrest frame and the lower backrest frame causes a change in the distance of the lumbar support transversely to a plane spanned by the first and second pivot axes.

The lumbar support allows additional mobilization in the lower back region and in this way counteracts the negative consequences of a lack of movement. In addition, the lumbar support can improve the quality of breathing in conjunction with targeted controlling of the second actuator to adjust the angle between the two backrest frames.

In one embodiment of the lumbar support, it has a lumbar support plate and at least one support element holding the lumbar support plate, wherein the support element is fastened to the upper backrest frame in such a way that a part of the support element penetrates a plane spanned by the first and second pivot axes in a region between the first and second pivot axes. It is also conceivable that the lumbar support has a lumbar support plate and that the lumbar support can be fastened to the upper backrest frame in at least two positions in which the lumbar support plate has different distances from the second pivot axis. Furthermore, the lumbar support can be fastenable to the upper backrest frame in at least two positions in which the lumbar support plate has different distances from a plane spanned by the first and second pivot axes. In a further embodiment of the invention, the lumbar support can be fastened to the upper backrest frame so as to be adjustable in two directions, wherein the two directions enclose an angle of 90°+/−20°. The positioning adjustments of the lumbar support offer the possibility of adapting the lumbar support to different geometries of the chair mechanism or different upholstering of the item of furniture for sitting and reclining.

To further increase comfort for the user, it is advantageous if the user's head can be laid down. This can be achieved on the one hand by a backrest made correspondingly long, in particular a correspondingly extended upper backrest frame, or on the other hand by providing a headrest. The headrest would be coupled to the upper backrest frame so that it can pivot around a third pivot axis. Furthermore, a third actuator could be provided to adjust the angle between the headrest and the upper backrest frame. For the third actuator, a pivot range around the third pivot axis of 50°+/−5° has proven to be particularly advantageous, wherein the third actuator can be designed to adjust the angle between the headrest and the upper backrest frame—measured at the front side of the chair mechanism—between a minimum angle of 150° and a maximum angle of 200°, in each case+/−10°.

According to a particular embodiment of the invention, a control unit is provided for controlling the first and/or second actuator and/or third actuator (if present), wherein the control unit has at least two different program sequences in which one or more of the actuators are operated at an adjustable speed such that the angle adjustable by the corresponding actuator repeatedly changes continuously between a specified minimum angle and a specified maximum angle.

Furthermore, a control unit for controlling the second actuator can be provided, which is designed such that the angle between the lower and the upper backrest frames can be continuously changed about the second pivot axis in several cycles between a minimum angle and a maximum angle at a specified speed.

The actuators are preferably designed as linear motors with an electric motor, a threaded spindle, and a spindle nut that can be adjusted by rotating the threaded spindle, and the actuators can be adjusted at a speed adapted to the corresponding program sequence. Speeds in the range of 0.3 to 50 mm/s are conceivable. For a micromobilization program, a speed in the range of 0.3 to 2 mm/s, for a normal mobilization program a speed in the range of 4 to 8 mm/s, and for a respiratory program a speed in the range of 30 to 50 mm/s, have proven to be particularly advantageous.

Further embodiments of the invention are explained in more detail with reference to the following description and the drawings.

In the drawings:

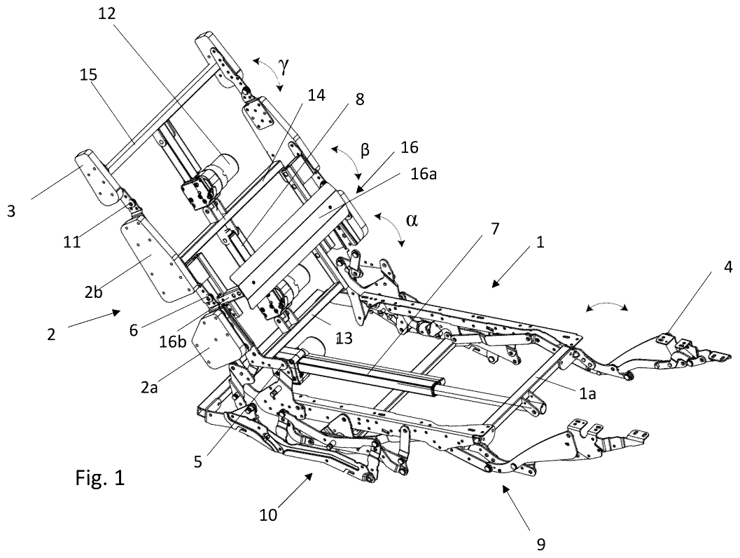

FIG. 1 shows a three-dimensional representation of a chair mechanism according to a first exemplary embodiment,

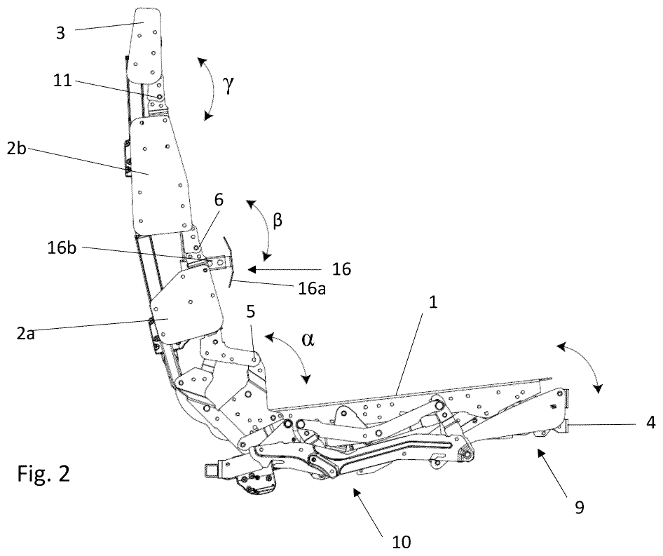

FIG. 2 shows a side view of the chair mechanism according to FIG. 1 in an upright basic position with folded-up footrest,

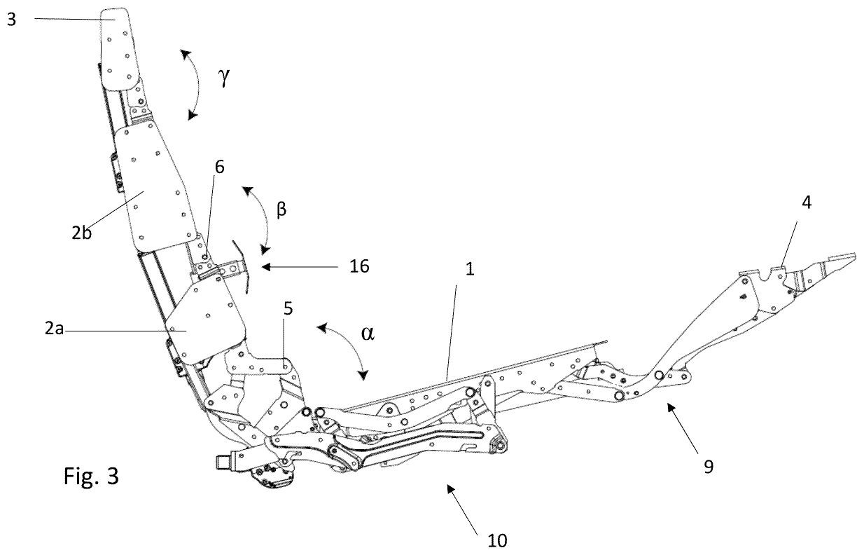

FIG. 3 shows a side view of the chair mechanism according to FIG. 1 in a first reclining position with extended footrest,

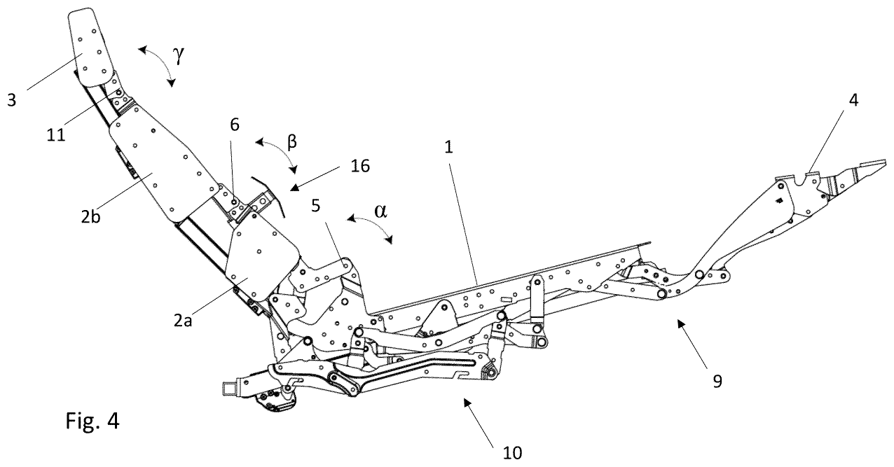

FIG. 4 shows a side view of the chair mechanism according to FIG. 1 in a second reclining position with extended footrest,

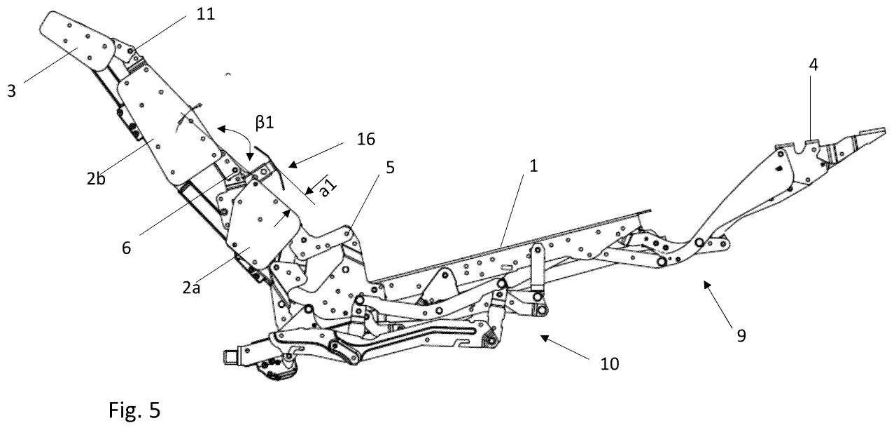

FIG. 5 shows a side view of the chair mechanism according to FIG. 1 in a first position of the respiratory program sequence,

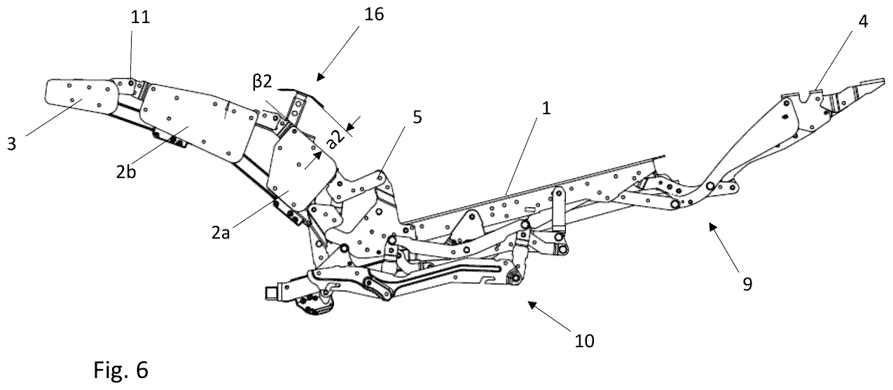

FIG. 6 shows a side view of the chair mechanism according to FIG. 1 in a second position of the respiratory program sequence,

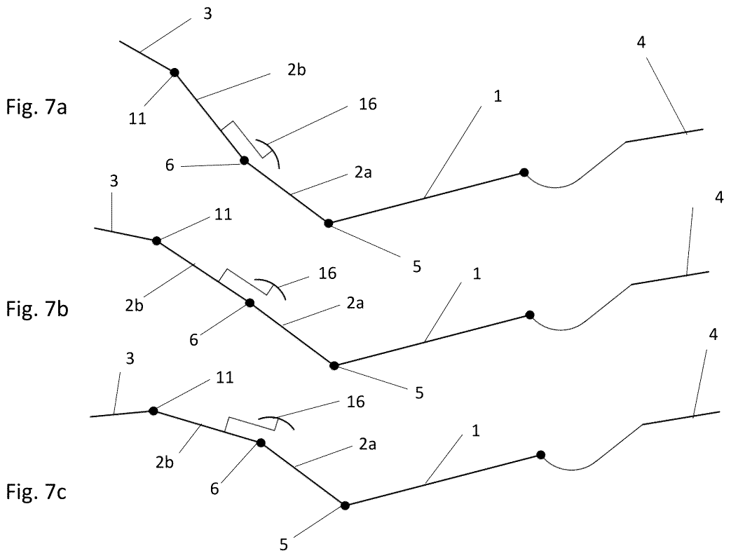

FIGS. 7a to 7c show three schematic representations of the chair mechanism during the respiratory program sequence,

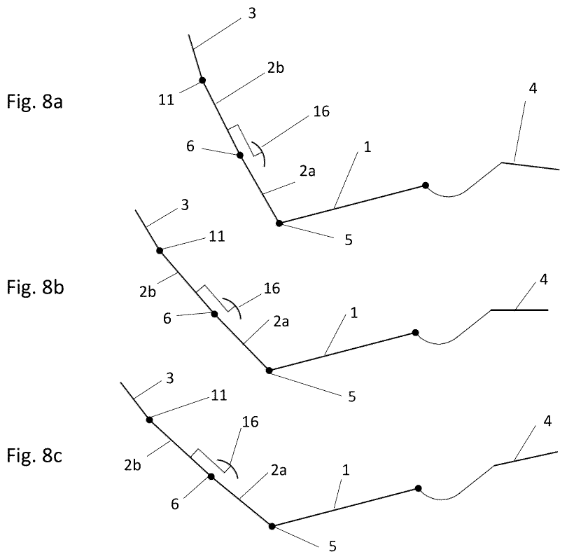

FIGS. 8a to 8c show three schematic representations of the chair mechanism during the micromobilization program sequence,

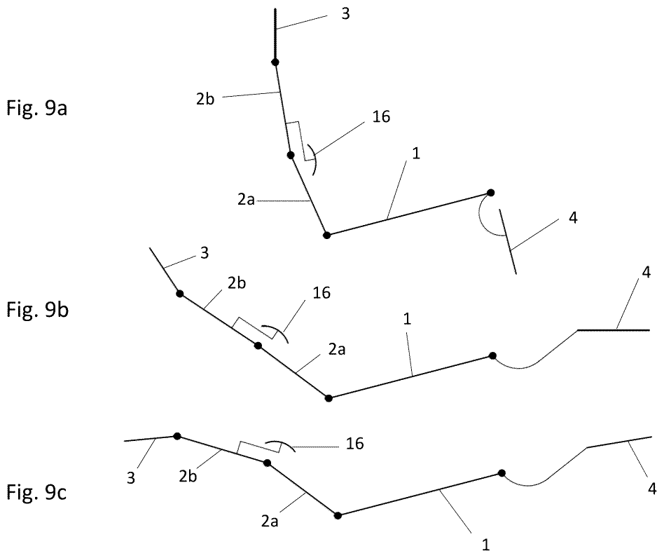

FIGS. 9a to 9c show three schematic representations of the chair mechanism during the mobilization program sequence,

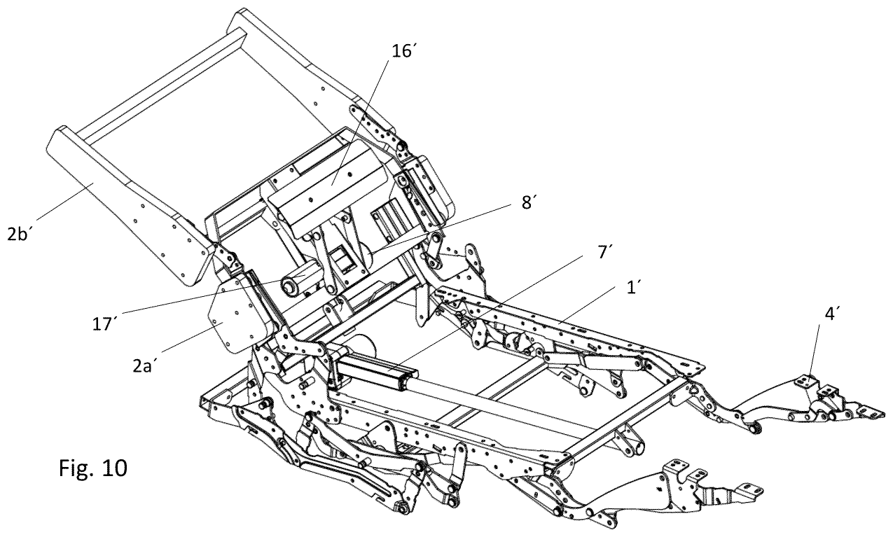

FIG. 10 shows a three-dimensional representation of a chair mechanism according to a second exemplary embodiment,

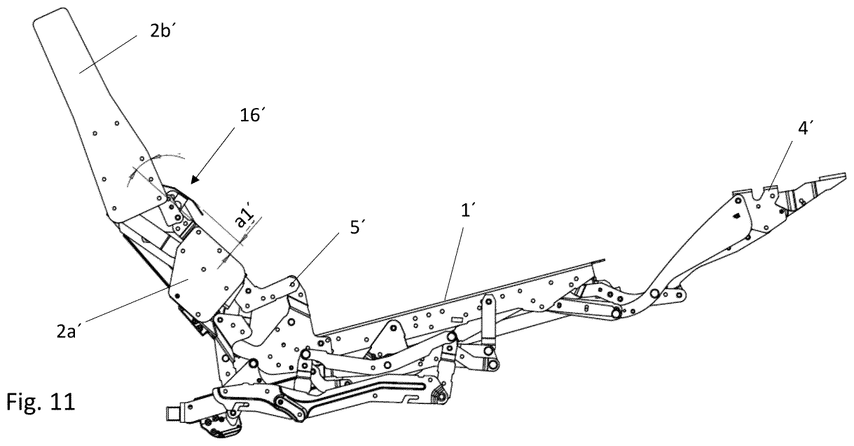

FIG. 11 shows a side view of the chair mechanism according to FIG. 10 in a first position of the respiratory program sequence,

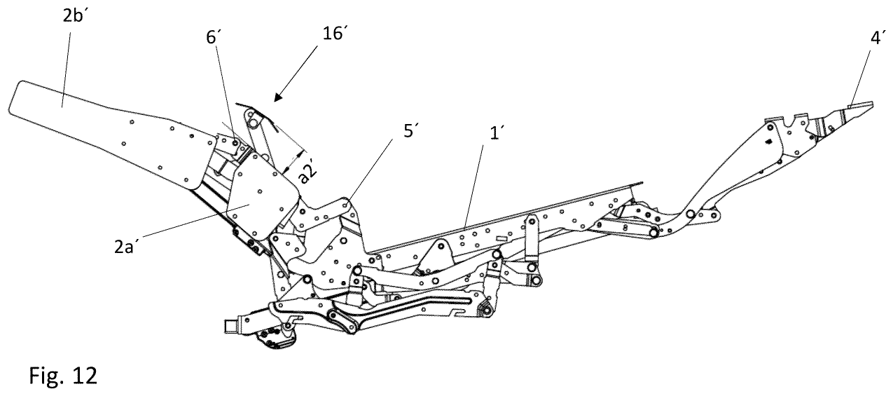

FIG. 12 shows a side view of the chair mechanism according to FIG. 10 in a second position of the respiratory program sequence.

In FIGS. 1 to 6, a first embodiment of a chair mechanism according to the invention for an item of furniture for sitting and reclining is shown in different views and positions. It essentially comprises a seat 1, a backrest 2, a headrest 3, and a footrest 4, wherein the backrest 2 provides a lower backrest frame 2a and an upper backrest frame 2b. Here the seat is coupled to the lower backrest frame 2a so as to be capable of pivoting about a first pivot axis 5 and the lower backrest frame 2a is coupled to the upper backrest frame 2b so as to be capable of pivoting about a second pivot axis 6, wherein a first actuator 7 is provided for adjusting the angle α between the seat 1 and the lower backrest frame 2a and a second actuator 8 is provided for adjusting the angle β between the lower backrest frame 2a and the upper backrest frame 2b.

A footrest adjustment mechanism 9 is provided for extending and retracting the footrest 4 between the positions shown in FIGS. 2 and 3. In addition, a seat and backrest adjustment mechanism 10 is provided for changing the position of seat 1 and/or backrest 2. The footrest adjustment mechanism 9 and the seat and backrest adjustment mechanism 10 interact with the first actuator 7 in such a way that a first actuation of the first actuator 7, starting from the upright basic position shown in FIG. 2, causes the footrest 4 to extend into the first reclining position shown in FIG. 3. A further actuation of the first actuator 7 then leads to an increase in the angle α between the seat 1 and the lower backrest frame 2a, so that the second reclining position according to FIG. 4 is reached. For further details regarding the footrest adjustment mechanism 9 and the seat and backrest adjustment mechanism 10, reference is hereby made to DE 20 2019 100 213 U1.

The headrest 3 is coupled to the upper backrest frame 2b so as to be capable of pivoting about a third pivot axis 11, wherein a third actuator 12 is provided for adjusting the angle γ between the headrest 3 and the upper backrest frame 2b.

The seat 1 has a seat frame 1a to which one end of the first actuator 7 is attached. The other end of the first actuator 7 is coupled to the seat and backrest adjustment mechanism 10. The lower backrest frame 2a has a lower cross-member 13, while the upper backrest frame 2b provides an upper cross-member 14, wherein the second actuator is coupled at one end to the lower cross-member 13 and at the other end to the upper cross-member. The third actuator 12 is arranged between the upper cross-member 14 and a headrest cross-member 15.

The three actuators 7, 8, 12 are arranged with respect to their associated pivot axes 5, 6, 11 in such a way that they can realize the pivot range desired in each case. Thus, the first actuator 7 is expediently designed for a pivot range about the first pivot axis 5 of 25°+/−5°, wherein the first actuator 7 can adjust the angle α between the seat 1 and the lower backrest frame 2a—measured at a front side of the chair mechanism—preferably between a minimum angle of 100° and a maximum angle of 125°, in each case+/−10°. The second actuator 8 is expediently designed for a pivot range about the second pivot axis 6 of 35°+/−5°, wherein the second actuator 8 can adjust the angle β between the lower backrest frame 2a and the upper backrest frame 2b—measured at a front side of the chair mechanism—preferably between a minimum angle of 165° and a maximum angle of 200°, in each case+/−10°. The third actuator 12 is expediently designed for a pivot range about the third pivot axis 11 of 50°+/−5°, wherein the second actuator 8 can adjust the angle γ between the lower backrest frame 2a and the upper backrest frame 2b—measured at a front side of the chair mechanism—preferably between a minimum angle of 150° and a maximum angle of 200°, in each case+/−10°.

The exemplary embodiment according to the invention further provides a lumbar support 16, which is here fastened to the upper backrest frame 2b and can pivot with the upper backrest frame 2b about the second pivot axis 6. The lumbar support 16 has a lumbar support plate 16a which extends transversely to a longitudinal center axis of the chair mechanism in the region of the lower backrest frame 2a and provides at least one support element 16b holding the lumbar support plate 16a, wherein the support element 16b is fastened to the upper backrest frame 2b such that a part of the support element 16b penetrates a plane spanned by the first and second pivot axes 5, 6 in a region between the first and second pivot axes 5, 6 (cf. FIGS. 5 and 6).

In this way, the lumbar support plate projects on the front side of the seat mechanism and can perform the usual function of a lumbar support, wherein the distance of the lumbar support plate 16a from the lower backrest frame 2a changes when the second actuator 8 is actuated, as is particularly clear from a comparison of the two positions shown in FIGS. 5 and 6. Thus, in FIG. 5 an angle β1 of 165° is set between the lower backrest frame 2a and the upper backrest frame 2b—measured at a front side of the chair mechanism—while in the position according to FIG. 6 an angle β2 of 200° is set between the lower backrest frame 2a and the upper backrest frame 2b, measured at a front side of the chair mechanism. As the lumbar support 16 rotates with the upper backrest frame 2b about the second pivot axis 6, the distance of the lumbar support 16 from the lower backrest frame 2a also changes. For example, in the position according to FIG. 5 this distance a1 is about 20 mm, while in FIG. 6 the distance measures about 70 mm.

In addition to the adjustment of the lumbar support 16 relative to the lower backrest frame 2a by actuating the second actuator 8, it can also be provided that the lumbar support 16 can be fastened to the upper backrest frame 2b so as to be adjustable in two directions, wherein the two adjustment directions preferably enclose an angle of 90°+/−20°. In the embodiment shown, the support element 16b is formed by two arms in an L-shaped configuration, each of which is telescopically adjustable so that the distance of the lumbar support plate can be adjusted in two directions.

The three actuators 7, 8 and 12 can be controlled in a targeted manner via a control unit (not shown in detail) in order to set individually desired positions or to move to pre-programmed positions, such as the positions according to FIGS. 2, 3 and 4.

In addition to moving to individual or pre-programmed positions, the control unit can be designed to control the first and/or second actuator and/or third actuator, but also to carry out different program sequences in which one or more of the actuators 7, 8, 12 are operated at an adjustable speed such that the angle adjustable by the corresponding actuator repeatedly changes continuously between a specified minimum angle and a specified maximum angle, each program sequence being repeated in a plurality of cycles.

On the basis of FIGS. 7a to 7c, 8a to 8c and 9a to 9c, three different program sequences are presented below. Within the scope of the invention, however, these program sequences can also be modified or constructed completely differently.

FIGS. 7a to 7c show a respiratory program sequence that is particularly suitable for regulating the heart rhythm of the user resting on the item of furniture for sitting and reclining, increasing heart rate variability and synchronizing the activities of the sympathetic and parasympathetic nervous systems. It can also be used to reduce pressure on the intervertebral discs and make the spine more flexible.

The footrest 4 is here in an extended position and a maximum angle of, for example, 125° is set between the seat 1 and the lower backrest frame 2a. The headrest 3 is in a folded-back position. In the respiratory program sequence, only the second actuator 8 is then actuated in such a way that the angle—measured at a front side of the chair mechanism—between the lower backrest frame 2a and the upper backrest frame 2b moves continuously between a minimum angle of 165° and a maximum angle of 200°, in each case+/−10°. FIG. 7a shows the position with the minimum angle, while FIG. 7c shows the maximum angle. An intermediate position is shown in FIG. 7b. A cycle begins with the position shown in FIG. 7a, passes through the position shown in FIG. 7b to the position shown in FIG. 7c, before the movement is then carried out in reverse through the position shown in FIG. 7b back to the position shown in FIG. 7a. The respiratory program sequence is designed for a large number of such cycles and can be terminated either manually or after a specified number of cycles. The second actuator 8 is operated in the respiratory program sequence at a speed of approximately 40 mm/s+/−10 mm/s. One cycle then lasts about 10 seconds.

FIGS. 8a to 8c show a micromobilization program sequence that performs a smooth, barely perceptible movement, which enables stimulation of the muscles and relaxation. The footrest 4 is again in an extended position and an angle of less than 180°, preferably about 175°, is set between the lower backrest frame 2a and the upper backrest frame 2b, measured at a front side of the chair mechanism. The headrest 3 is in a slightly forward-tilted position. In the micromobilization program sequence, only the first actuator 7 is then actuated in such a way that the angle—measured at a front side of the chair mechanism—between the seat 1 and the lower backrest frame 2a moves continuously between a minimum angle of 100° and a maximum angle of 125°, in each case+/−10°. FIG. 8a shows the position with the minimum angle, while FIG. 8c shows the maximum angle. In FIG. 8b an intermediate position is again shown. The micromobilization program sequence is also designed for a large number of such cycles (FIG. 8a, FIG. 8b, FIG. 8c, FIG. 8b, FIG. 8a) and can be terminated either manually or after a prespecified number of cycles or after a certain time, for example 1 to 2 hours. The first actuator 7 is operated in the micromobilization program sequence at a comparatively very slow speed of about 0.9 mm+/−0.6 mm/s. One cycle then lasts about 10 minutes.

FIGS. 9a to 9c show a mobilization program sequence that mobilizes the whole body of a person reclining on the item of furniture for sitting and reclining. In the initial position according to FIG. 9a, the footrest 4 is in a half-extended position. A minimum angle of approximately 100° is set between the seat and the lower backrest frame 2a. The upper backrest frame 2b is positioned slightly forward compared to the lower backrest frame 2a. The headrest 4 is also in a slightly forward-tilted position. To reach the intermediate position according to FIG. 9b, the first actuator 7 is actuated until a maximum angle of approximately 125° is reached between the seat and the lower backrest frame. The second actuator 8 is also actuated to set an angle between the lower backrest frame 2a and the upper backrest frame 2b—measured at a front side of the chair mechanism—greater than 180°, preferably approximately 190°. The headrest 3 initially remains in its slightly forward-tilted position. In order to reach the position shown in FIG. 9c, on the one hand the second actuator 8 is driven in order to increase the angle between the lower backrest frame 2a and the upper backrest frame 2b, so that an angle of for example 200° is established. Furthermore, the headrest is brought into a folded-back position. The mobilization program sequence is also designed for a large number of such cycles (FIG. 9a, FIG. 9b, FIG. 9c, FIG. 9b, FIG. 9a) and can be terminated either manually or after a prespecified number of cycles or after a certain time, for example 15 minutes. The three actuators 7, 8, 12 are operated in the mobilization program sequence at a speed of approximately 6 mm/s+/−2 mm/s. This results in a cycle duration of approximately 1 to 2 minutes.

In FIGS. 10 to 12, a seat mechanism according to a second embodiment is shown, which differs from the previously described first embodiment primarily in that no headrest is provided and therefore the upper backrest frame 2b′ is made correspondingly longer. Otherwise, the chair mechanism further comprises a seat 1′, a lower backrest frame 2a′ and a footrest 4′, as well as a first actuator 7′ and a second actuator 8′, which interact in the same way as in the first embodiment. An actuation of the first actuator 7′ thus causes an adjustment of the angle between the seat 1′ and the lower backrest frame 2a′, while the second actuator 8′ adjusts the angle between the lower backrest frame 2a′ and the upper backrest frame 2b′.

In contrast to the first embodiment, the lumbar support 16′ is attached to the lower backrest frame 2a′ and is adjusted with a fourth actuator 17′ as regards its distance from the lower backrest frame 2a′.

FIGS. 11 and 12 show the two extreme positions of the respiratory program sequence for this second embodiment. In the position according to FIG. 11, the second actuator 8′ sets an angle between the lower backrest frame 2a′ and the upper backrest frame 2b′-measured at a front side of the chair mechanism—of for example 155°. The lumbar support 16′ is adjusted by means of the fourth actuator 17′ to a distance a1′ of for example 20 mm from the lower backrest frame 2a′. In order to reach the position according to FIG. 12, the second actuator 8′ is operated in such a way that an angle of for example 200° is set between the lower backrest frame 2a′ and the upper backrest frame 2b′, measured at a front side of the chair mechanism. At the same time, the distance a2′ of the lumbar support 16′ is changed to, for example, 70 mm by means of the fourth actuator 17′. Both actuators are operated continuously, and a plurality of cycles are run through.

The second embodiment can also be used for further program sequences.

The invention claimed is:

1. A chair mechanism for an item of furniture for sitting and reclining having a seat (1) and a backrest (2), wherein the backrest (2) has a lower backrest frame (2a) and an upper backrest frame (2b), and the lower backrest frame (2a) is coupled to the seat (1) so as to be capable of pivoting about a first pivot axis (5) and the lower backrest frame (2a) is coupled to the upper backrest frame (2b) so as to be capable of pivoting about a second pivot axis (6), and wherein a first actuator (7) is provided for adjusting the angle between the seat (1) and the lower backrest frame (2a) and a second actuator (8) is provided for adjusting the angle between the lower backrest frame (2a) and the upper backrest frame (2b), and wherein a lumbar support (16) is provided which is attached to the upper or lower backrest frame (2b, 2a) and is adjustably mounted relative to the lower and/or upper backrest frame (2a, 2b).

2. The chair mechanism according to claim 1, characterized in that the first actuator (7) is designed for a pivot range about the first pivot axis of 25°+/−5°.

3. The chair mechanism according to claim 1, characterized in that the second actuator (8) is designed for a pivot range about the second pivot axis of 35°+/−5°.

4. The chair mechanism according to claim 1, characterized in that the first actuator (7) is designed to adjust the angle between the seat (1) and the lower backrest frame (2a)—measured at a front side of the chair mechanism—between a minimum angle of 100° and a maximum angle of 125°, in each case+/−10°.

5. The chair mechanism according to claim 1, characterized in that the second actuator (8) is designed to adjust the angle between the lower backrest frame (2a) and the upper backrest frame (2b)—measured at a front side of the chair mechanism—between a minimum angle of 155° and a maximum angle of 200°, in each case+/−10°.

6. The chair mechanism according to claim 1, characterized in that a footrest (4) is also provided, which is mounted on the seat (1) so as to be retractable and extendable.

7. The chair mechanism according to claim 1, characterized in that the lumbar support (16) is attached to the upper backrest frame (2b) and can be pivoted with the upper backrest frame (2b) about the second pivot axis (6).

8. The chair mechanism according to claim 1, characterized in that a further actuator is provided for the relative adjustment of the lumbar support (16) in relation to the upper and/or lower backrest frames (2b, 2a).

9. The chair mechanism according to claim 1, characterized in that the lumbar support (16) has a lumbar support plate (16a) which extends transversely to a longitudinal center axis of the chair mechanism in the region of the lower backrest frame (2a).

10. The chair mechanism according to claim 9, characterized in that the lumbar support (16) is arranged such that the distance of the lumbar support plate (16a) relative to the lower backrest frame (2a) changes upon actuation of the second actuator (8).

11. The chair mechanism according to claim 1, characterized in that the lumbar support (16) is arranged such that an adjustment of the angle between the upper backrest frame (2b) and the lower backrest frame (82a) causes a change in the distance of the lumbar support (16) transversely to a plane spanned by the first and second pivot axes (5, 6).

12. The chair mechanism according to claim 1, characterized in that the lumbar support (16) has a lumbar support plate (16a) and at least one support element (16b) holding the lumbar support plate (16a), wherein the support element (16b) is fastened to the upper backrest frame (2b) in such a way that a part of the support element (16b) penetrates a plane spanned by the first and second pivot axes (5, 6) in a region between the first and second pivot axes (5, 6).

13. The chair mechanism according to claim 1, characterized in that the lumbar support (16) has a lumbar support plate (16a) and the lumbar support (16a) can be fastened to the upper backrest frame (2b) in at least two positions in which the lumbar support plate (16a) has different distances from the second pivot axis (6).

14. The chair mechanism according to claim 1, characterized in that the lumbar support (16) has a lumbar support plate (16a) and the lumbar support (16) can be fastened to the upper backrest frame (2b) in at least two positions in which the lumbar support plate (16a) has different distances from a plane spanned by the first and second pivot axes (5, 6).

15. The chair mechanism according to claim 1, characterized in that the lumbar support (16) can be fastened to the upper backrest frame (2b) so as to be adjustable in two directions, wherein the two directions enclose an angle of 90°+/−20°.

16. The chair mechanism according to claim 1, characterized in that a headrest (3) is also provided which is coupled to the upper backrest frame (2b) so as to be capable of pivoting about a third pivot axis (11) and a third actuator (12) is provided for adjusting the angle between the headrest (3) and the upper backrest frame (2b).

17. The chair mechanism according to claim 16, characterized in that the third actuator (12) is designed for a pivot range about the third pivot axis (11) of 50°+/−5°.

18. The chair mechanism according to claim 16, characterized in that the third actuator (12) is designed to adjust the angle between the headrest (3) and the upper backrest frame (2b)—measured at a front side of the chair mechanism—between a minimum angle of 150° and a maximum angle of 200°, in each case+/−10°.

19. The chair mechanism according to claim 1, characterized in that a control unit is provided for controlling the first and/or second and/or third actuator (7, 8, 12), wherein the control unit has at least two different program sequences in which one or more of the three actuators (7, 8, 12) are operated at an adjustable speed such that the angle adjustable by the corresponding actuator repeatedly changes continuously between a specified minimum angle and a specified maximum angle.

20. The chair mechanism according to claim 1, characterized in that a control unit is provided for controlling the second actuator (8), which is designed such that the angle between the lower and the upper backrest frame (2a, 2b) about the second pivot axis (6) can be continuously changed in a plurality of cycles between a minimum angle and a maximum angle at a specified speed.
